(19) United States
(12) Patent Application Publication
(10) Pub. No.: US 2015/0248677 A1
(43) Pub. Date: Sep. 3, 2015

(54) TRANSPORTATION COMPLIANCE SYSTEM

(71) Applicants: Joseph F. Mundt, McKinney, TX (US); Denis Wauson, Yoakum, TX (US)

(72) Inventors: Joseph F. Mundt, McKinney, TX (US); Denis Wauson, Yoakum, TX (US)

(21) Appl. No.: 14/193,873

(22) Filed: Feb. 28, 2014

(51) Int. Cl. G06Q 30/00; G06Q 50/28

(52) U.S. Cl. CPC G06Q 30/018; G06Q 50/28

(57) ABSTRACT

An apparatus and method determine compliance with transportation regulations using a server computer and a data storage. The data storage contains a driver qualification file for each of one or more drivers. The server computer receives a driver application data for a specified driver of the one or more drivers, stores and logs the driver application data in the driver qualification file for the specified driver, receives a driver data for the specified driver of the one or more drivers, stores and logs the driver data in the driver qualification file for the specified driver, performs an electronic audit of the driver qualification file for the specified driver to determine whether the driver application data and driver data within the driver qualification file complies with the set of transportation regulations, and provides a result of the electronic audit to a client device communicably coupled to the server computer.

### FIELD OF THE INVENTION

The present invention relates generally to the field of transportation and, more particularly, to a transportation compliance system.

### PRIORITY CLAIM AND CROSS-REFERENCE TO RELATED APPLICATIONS

None.

### STATEMENT OF FEDERALLY FUNDED RESEARCH

None.

### BACKGROUND OF THE INVENTION

Commercial Motor Vehicles (“CMV”), trucking companies (often referred to a “carriers”) and drivers within the United States operate under various regulations enforced by federal and state regulatory agencies, such the Department of Transportation (“DOT”) and the Federal Motor Carrier Safety Administration (“FMCSA”). These regulations govern many aspects related to the operation of CMVs ranging from vehicle maintenance to driver qualifications and performance. Data relating to the CMVs and drivers must be recorded and made available for inspection by the federal and state regulatory agencies.

Vehicle-based electronic logging systems have been developed to record and monitor drivers while they are operating the CMVs, and then wirelessly transmit the data to a remote server computer. An example of such systems can be found in U.S. Pat. No. 8,442,508, U.S. Patent Application Publication 2008/0016504 and U.S. Patent Application Publication 2013/0226397, which are hereby incorporated by reference in their entirety. These systems, however, only address one part of the regulatory compliance puzzle and do not provide an integrated platform to electronically monitor and audit a carrier's compliance with federal and state regulations.

As a result, there is a need for a transportation compliance system that electronically monitors and audits all aspects of a carrier's compliance with federal and state regulations; not merely vehicle and driver data logging.

### SUMMARY OF THE INVENTION

The present invention provides a transportation compliance system that electronically monitors and audits all aspects of a carrier's compliance with federal and state regulations; not merely vehicle and driver data logging.

For example, one embodiment of the present invention provides an apparatus or system for determining compliance with a set of transportation regulations. The apparatus or system includes a server computer and a data storage communicably coupled to the server computer. The data storage contains a driver qualification file for each of one or more drivers. The server computer has a computer program embodied on a non-transitory computer readable medium that when executed causes the server computer to receive a driver application data for a specified driver of the one or more drivers, store and log the driver application data in the driver qualification file for the specified driver, receive a driver data for the specified driver of the one or more drivers, store and log the driver data in the driver qualification file for the specified driver, perform an electronic audit of the driver qualification file for the specified driver to determine whether the driver application data and driver data within the driver qualification file complies with the set of transportation regulations, and provide a result of the electronic audit to a client device communicably coupled to the server computer.

The present invention also provides computerized method for determining compliance with a set of transportation regulations. A server computer, and a data storage communicably coupled to the server computer are provided. The data storage contains a driver qualification file for each of one or more drivers. A driver application data for a specified driver of the one or more drivers is received by the server computer. The driver application data is stored and logged in the driver qualification file for the specified driver by the server computer. A driver data for the specified driver of the one or more drivers is received by the server computer. The driver data is stored and logged in the driver qualification file for the specified driver by the server computer. An electronic audit of the driver qualification file for the specified driver is performed by the server computer to determine whether the driver application data and driver data within the driver qualification file complies with the set of transportation regulations. A result of the electronic audit is provided to a client device communicably coupled to the server computer. The method can be implemented as a computer program embodied on a non-transitory computer readable medium in which the computer program when executed by a processor causes the processor to perform the steps.

In addition, the present invention provides a computerized method for determining compliance with a set of transportation regulations. A server computer, and a data storage communicably coupled to the server computer are provided. The data storage containing a driver qualification file for each of one or more drivers. A completed employment application for the specified driver is received by the server computer. The completed employment application for the specified driver is stored and logged in a driver qualification file for the specified driver on the data storage by the server computer. An alcohol and/or drug testing result for the specified driver is received by the server computer. The alcohol and/or drug testing result is stored and logged in the driver qualification file for the specified driver on the data storage by the server computer. One or more electronic requests for a historical record for the specified driver are automatically sent to one or more third-party databases or services. The electronic requests are stored and logged in the driver qualification file for the specified driver by the server computer. One or more of the electronic requests for historical records for the specified driver are resent by the server computer whenever the historical records have not been received within a first specified period of time. A renewal notification for the specified driver is sent electronically from the server computer to a client device at a second specified time period before a license expiration date, and storing and logging the renewal notification in the driver qualification file for the specified driver by the server computer. A renewal report for the specified driver is received at the server computer and the renewal report is stored and logged in the driver qualification file for the specified driver on the data storage by the server computer. A training notification for the specified driver is sent electronically from the server computer to the client device at a third specified time period before a training expiration date, and the training notification is stored and logged in the driver qualification file for the specified driver by the server computer. A training report for the specified driver is received at the server computer, and the training report is stored and logged in the driver qualification file for the specified driver on the data storage by the server computer. An audit check on the driver qualification file is periodically and automatically performed, and one or more results or alerts based on the audit check are provided to the client device by the server computer. An hours-in-service data for the specified driver is received from one or more third-party devices, the hours-in-service data for the specified driver is analyzed, and any violations or potential violations are provided to the client device by the server computer. An audit check of an equipment is periodically and automatically performed based on an equipment data file stored on the data storage, and a result of the audit check of the equipment is provided to the client device by the server computer. The method can be implemented as a computer program embodied on a non-transitory computer readable medium in which the computer program when executed by a processor causes the processor to perform the steps.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 is a block diagram of an apparatus or system for determining compliance with a set of transportation regulations in accordance with one embodiment of the present invention;

FIG. 2 is a flow chart of a computerized method for determining compliance with a set of transportation regulations in accordance with one embodiment of the present invention;

FIGS. 3A & 3B are flow charts of a computerized method for determining compliance with a set of transportation regulations in accordance with another embodiment of the present invention;

FIG. 4 is a block diagram of a system overview of one embodiment of the present invention;

FIG. 5 is a block diagram of a logical architecture of one embodiment of the present invention;

FIG. 6 is a flow chart of a driver application process in accordance with one embodiment of the present invention;

FIG. 7 is a block diagram showing how the present invention can be categorized into two primary functions and three secondary functions;

FIG. 8 is a model diagram of one embodiment of the present invention; and

FIG. 9 is a flow chart of a driver application in accordance with one embodiment of the present invention is shown.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

The present invention provides a web-based, full-service compliance program that helps ensure both Federal and State DOT readiness for compliance reviews or focus interventions. The present invention promptly implements changes to all federal and state regulations to ensure that the carriers are informed of the changes and comply with the changes. The system is built for DOT federal and state auditors to enter the system for audits. This can reduce government expenses because the inspectors does not have to physically come to the carrier for their reviews. As a result, the present invention creates the potential for a seamless audit experience that will allow the carrier to focus on building and managing their business with minimal distraction from preparing for and experiencing government audits.

The present invention addresses each of the six component elements of a DOT compliance review and are designed to make compliance seamless and to reduce distractions from the carrier's important business. Compliance is implemented by means of a web-based paperless environment in which each item is preserved and accessible as long as required. The six component elements include Financial Responsibilities, Driver Qualification Requirements, Hour-in-Service Record Requirements, Vehicle Maintenance Record Requirements, Hazardous Material Record Requirements, and Crash Indicator Requirements.

Element One: Financial Responsibilities. The carrier must show that it is carrying sufficient and appropriate insurance coverage for its operations and for the type of commodity or commodities serviced. The present invention can interface with the carrier's current insurance provider or connect the carrier with longstanding insurance providers who are experts in your type of risk.

Element Two: Driver Qualification Requirements. There are two subcomponents to the requirements regarding drivers: Driver Qualification Files and DOT Part 382 Requirements.

Driver Qualification Files. The present invention automates driver qualification files. Everything that was time-consuming for human resources personnel to accumulate and manage—motor vehicle reports (“MVR”s), pre-employment screening programs (“PSP”s), criminal background checks, commercial drivers license information system (“CDLIS”) checks, Social Security checks, and transportation history checks—are done automatically when the driver completes his or her application. Then the prospective employer will send the applicant down for a pre-employment drug test. When test results come back, the present invention enables efficient requests, by email or fax, of the applicant's work history information, accident history information, and alcohol and drug testing information for the past three years (or more). This request will be automatically submitted, up to the required three attempts, until the inquiry has been answered. Each attempt will be date-stamped and time-stamped to record the carrier's good faith effort to complete this requirement. The system will also send out notifications of driver license renewal, physical exam renewals, annual reviews, and MVRs (within 15 days after the driver physical has been renewed following expiration of the previous physical, to ensure that the new expiration date has been updated on the MVR). This section will also include all of the other required documents for the driver qualification file, in a specific order that is easy for DOT auditors to follow.

DOT Part 382 Requirements. These requirements are the Pre-Employment Test, Random Drug Tests, Post-Accident Drug Tests, Reasonable Cause Drug Tests, Return to duty Drug Tests, and Follow-up Drug Tests. This section also includes one hour of driver supervisor training on drugs, and one hour of alcohol training, which must be documented and certified. The present invention handles and complies with the new CSA Map-21 requirement for driver orientation that mandates training the newly hired drivers on hours-in-service, alcohol and drug testing, and whistle blower protection, as well as on local company rules and regulations. The present invention can provide a downloadable company safety policy manual that can be modified to the carrier's individual company. The carrier will be able also to remove or add to the policies and procedures applicable to the carrier's specific needs. This manual also has a complete section dedicated to alcohol and drug testing requirements of the State DOT and the FMCSA DOT. It includes as well a Hazardous Materials section for Hazard Material haulers.

Element Three: Hour-in-Service Record Requirements. The present invention can interface with any electronic logging service that you have selected for your Electronic Recording Device Service. For example, U.S. Pat. No. 8,442,508 and U.S. Patent Application Publication 2013/0226397 disclose electronic driver logging systems. The present invention electronically monitors driver hours to ensure compliance. Paper logs are history and violations can't be changed, but with electronic logs, potential violations can be detected before they are actual violations and help keep those scores down. The present invention's monitoring services allow the driver and the driver's supervisor to be contacted to ensure violations are prevented before they happen. The carriers also scan their manifest, bill of ladings, or shipper's name and commodity types into the system so as to have available all required back-up support of the logs. This will also require payroll records to be entered in for back-up support.

Element Four: Vehicle Maintenance Record Requirements. All of the carrier's DOT-regulated equipment are entered into the system, and the system will alert the carrier to DOT/State Vehicle inspections and P.M. inspections when they are coming due. It will include required DOT data including unit number, model types, VIN numbers, number of tires, and size of tires. If the carrier uses electronic logs systems, the driver vehicle inspection report (“DVIR”) information will be forwarded to this section of the present invention and will be maintained for up to 90 days. The carrier can scan in all third-party vendor repair tickets and company repair tickets to maintain maintenance history on the equipment. This information will also help develop an average unit maintenance cost and average fleet cost.

Element Five: Hazardous Materials Record Requirements. Interactive videos, with tests, can be provided to cover required 90-day and three-year refresher company training. This is actually included in the driver orientation section for Hazardous Material carriers. The system will also ensure that drivers are retrained every three years, in a very user-accessible way. The drivers will be able to take the test either on the computer at the office or at home, and will be able to leave the system and come back to it later to finish. The Hazardous Material Registration system for Haz Mat carriers is automated, so that will be taken care of automatically as well. Tanker companies will scan in tanker inspections so that that portion will be available for review in an audit. The system will alert the carrier when the different type of inspections are coming due so that dispatchers will be able to have them scheduled before the due date. Security plans and an interactive worksheet for updating the security plan for the annual update requirement are also provided. In addition, security awareness training with test and certificate are provided.

Element Six: Crash Indicator Requirements. The electronic log system includes a vehicle accident register. Accident files can be created complete with police reports, pictures, driver statements, copies of tow tickets, vehicle repair tickets, any insurance correspondence, and safety department investigations. The system will automatically compute the carrier's accident-per-million-miles-of-operations ratio. This information will enable the carrier to always have up-date awareness of how the carrier stands in this area. A general note section is also provided for incidents or reprimands that need to be recorded and maintained so as to follow a driver's work record and performance in order to provide data for such matters as pay raises or termination. DOT is not permitted to access this section.

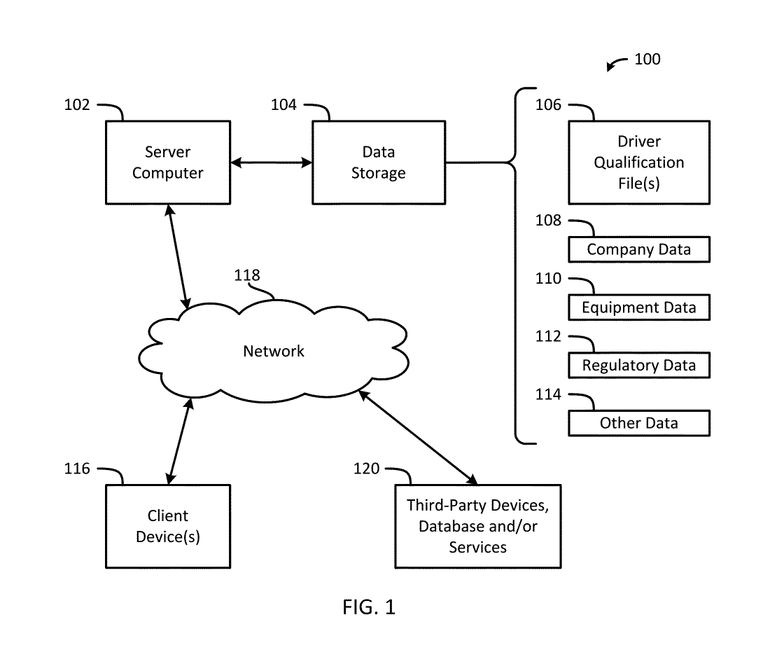

Now referring to FIG. 1, a block diagram of an apparatus or system 100 for determining compliance with a set of transportation regulations in accordance with one embodiment of the present invention is shown. The apparatus or system 100 includes a server computer 102 and a data storage 104 communicably coupled to the server computer 102. The data storage 104 contains a driver qualification file 106 for each of one or more drivers. As will be explained in more detail below, the data storage 104 may also contain company data 108, equipment data 110, regulatory data 112 and/or any other type of desired data 114. The server computer 102 has a computer program embodied on a non-transitory computer readable medium that when executed causes the server computer 102 to receive a driver application data for a specified driver of the one or more drivers, store and log the driver application data in the driver qualification file 106 for the specified driver, receive a driver data for the specified driver of the one or more drivers, store and log the driver data in the driver qualification file 106 for the specified driver, perform an electronic audit of the driver qualification file 106 for the specified driver to determine whether the driver application data and driver data within the driver qualification file 106 complies with the set of transportation regulations, and provide a result of the electronic audit to a client device 116 communicably coupled to the server computer 102.

The apparatus or system 100 may include a network 118 communicably coupling the server computer 102 to the client device 116. The network 118 can be the Internet, a wireless network, a public or private wide area or local area network, a cellular network, an optical network, a satellite network or a combination thereof. Note that the server computer 102 can be a distributed network of computers communicably coupled to one another, and the data storage 104 can be a distributed network of data storage devices communicably coupled to one another. The server computer 102 can be locally or remotely located with respect to the data storage 104. The server computer 102 preferably provides a web-based interface to the client device 116. The server computer 102 may also be communicably coupled to one or more third-party devices, databases or services 120. Note that the client device 116 can be a workstation, a client computer, a laptop, a mobile computing tablet, a mobile phone, an input and/or output device, a user interface on an equipment, or any other desirable device. Moreover, the client device 116 can be a carrier client device, a supervisor client device, a driver client device, an auditor client device, a third-party client device or a combination thereof.

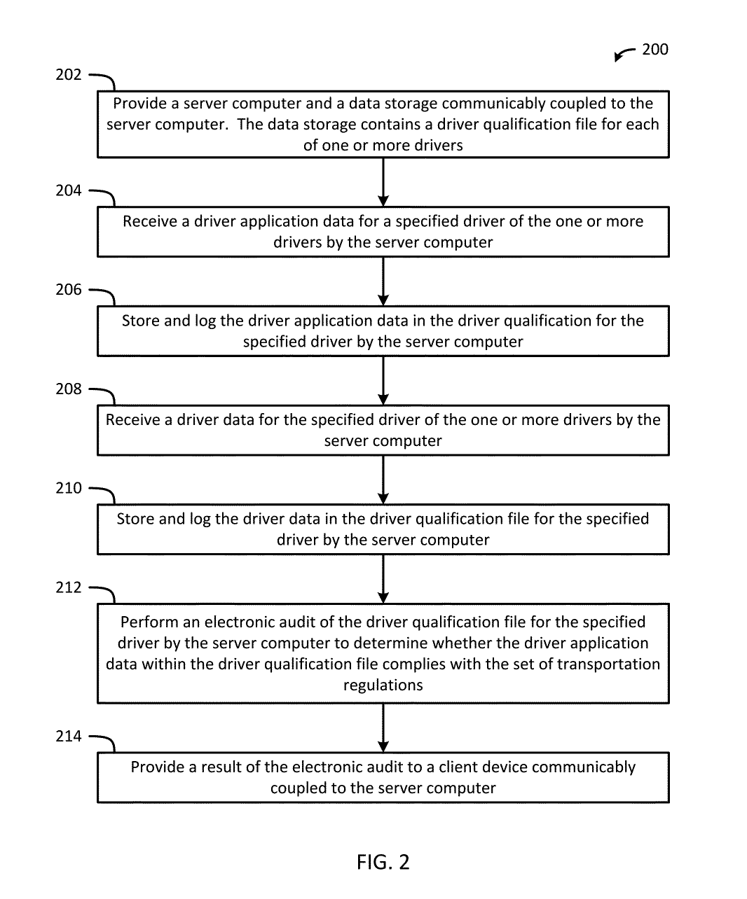

Referring now to FIG. 2, a flow chart of a computerized method 200 for determining compliance with a set of transportation regulations in accordance with one embodiment of the present invention is shown. A server computer, and a data storage communicably coupled to the server computer are provided in block 202. The data storage contains a driver qualification file for each of one or more drivers. A driver application data for a specified driver of the one or more drivers is received by the server computer in block 204. The driver application data is stored and logged in the driver qualification file for the specified driver by the server computer in block 206. The driver application data may include a completed employment application for the specified driver, an alcohol and/or drug testing result from the specified driver, a background check result for the specified driver, a certification data for the specified driver, a historical data for the specified driver, an orientation data, or a combination thereof. A driver data for the specified driver of the one or more drivers is received by the server computer in block 208. The driver data is stored and logged in the driver qualification file for the specified driver by the server computer in block 210. The driver data may include a renewal data for the specified driver, a training data for the specified driver, an hours-in-service data for the specified driver, one or more support documents for the specified driver, or a combination thereof. An electronic audit of the driver qualification file for the specified driver is performed by the server computer to determine whether the driver application data and driver data within the driver qualification file complies with the set of transportation regulations in block 212. A result of the electronic audit is provided to a client device communicably coupled to the server computer in block 214. The method can be implemented as a computer program embodied on a non-transitory computer readable medium in which the computer program when executed by a processor causes the processor to perform the steps.

Other steps may be performed. For example one or more of the following steps may be performed: (1) logging all changes to the driver qualification file with a date, time and source stamp; (2) locking the driver qualification file against unauthorized changes; (3) updating the set of transportation regulations; (4) sending an employment application for the specified driver electronically from the server computer to a client device, and the driver application data comprises a completed employment application for the specified driver; (5) receiving an interview data for the specified driver, and storing and logging the interview data in the driver qualification file for the specified driver when the driver application data includes a completed employment application for the specified driver; (6) changing a status of the specified driver based on the driver application data and the driver data within the driver qualification file for the specified driver; (7) automatically sending an electronic request for a historical data for the specified driver to one or more third-party databases or services, and logging the electronic request in the driver qualification file for the specified driver when the driver application data includes a completed employment application for the specified driver; (8) resending and logging the electronic request for the historical data for the specified driver whenever the historical data has not been received within a specified period of time; (9) automatically sending a renewal notification for the specified driver electronically from the server computer to a client device at a specified time period before an expiration date, and logging the renewal notification in the driver qualification file for the specified driver; (10) receiving a renewal report for the specified driver at the server computer, and saving and logging the renewal report in the qualification file for the specified driver on the data storage; (11) automatically sending a training notification for the specified driver electronically from the server computer to a client device at a specified time period before an expiration date, and logging the training notification in the driver qualification file for the specified driver; (12) receiving a training report for the specified driver at the server computer, and saving and logging the training report in the driver qualification file for the specified driver on the data storage; (13) receiving an hours-in-service data for the specified driver from one or more third-party databases or services, saving and logging the hours-in-service data in the driver qualification file for the specified driver on the data storage, and analyzing the hour-in-service data for the specified driver and reporting any violations or potential violations to the client device; (14) receiving one or more support documents for the hours-in-service data for the specified driver and storing one or more support documents in the driver qualification file; (15) receiving an equipment data for a specified equipment, and saving and logging the equipment data for the specified equipment on the data storage; and/or (16) periodically and automatically performing an audit check of the specified equipment, and providing a result of the audit check of the specified equipment to the client device.

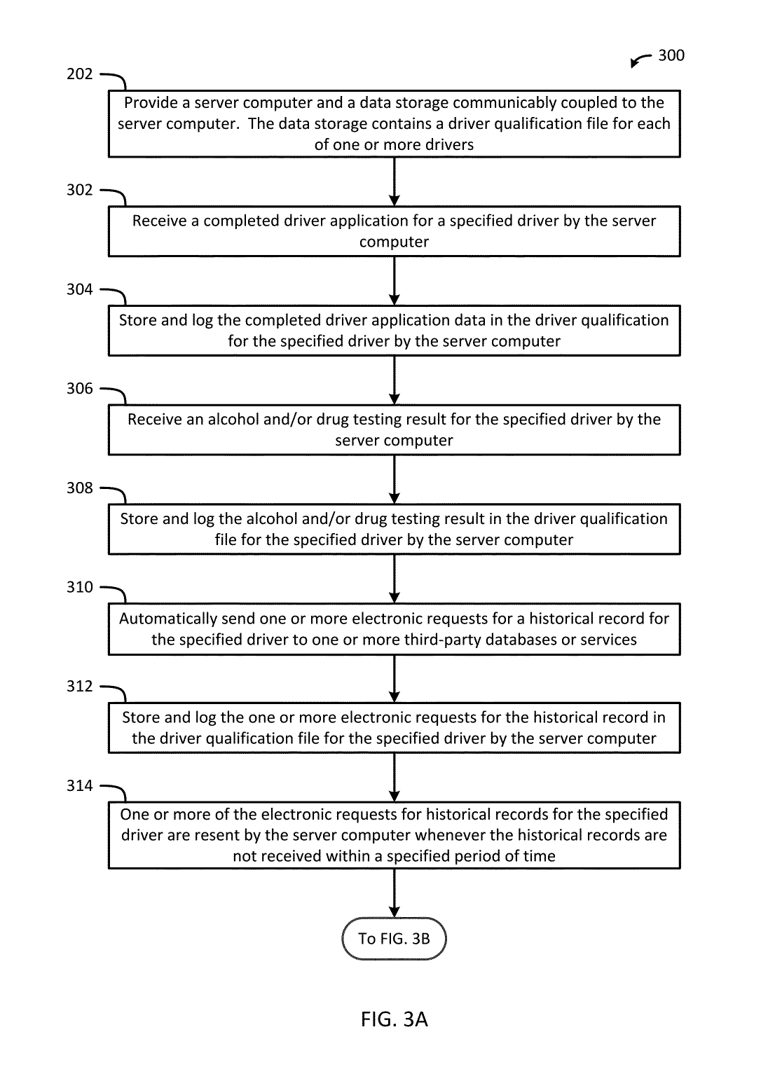

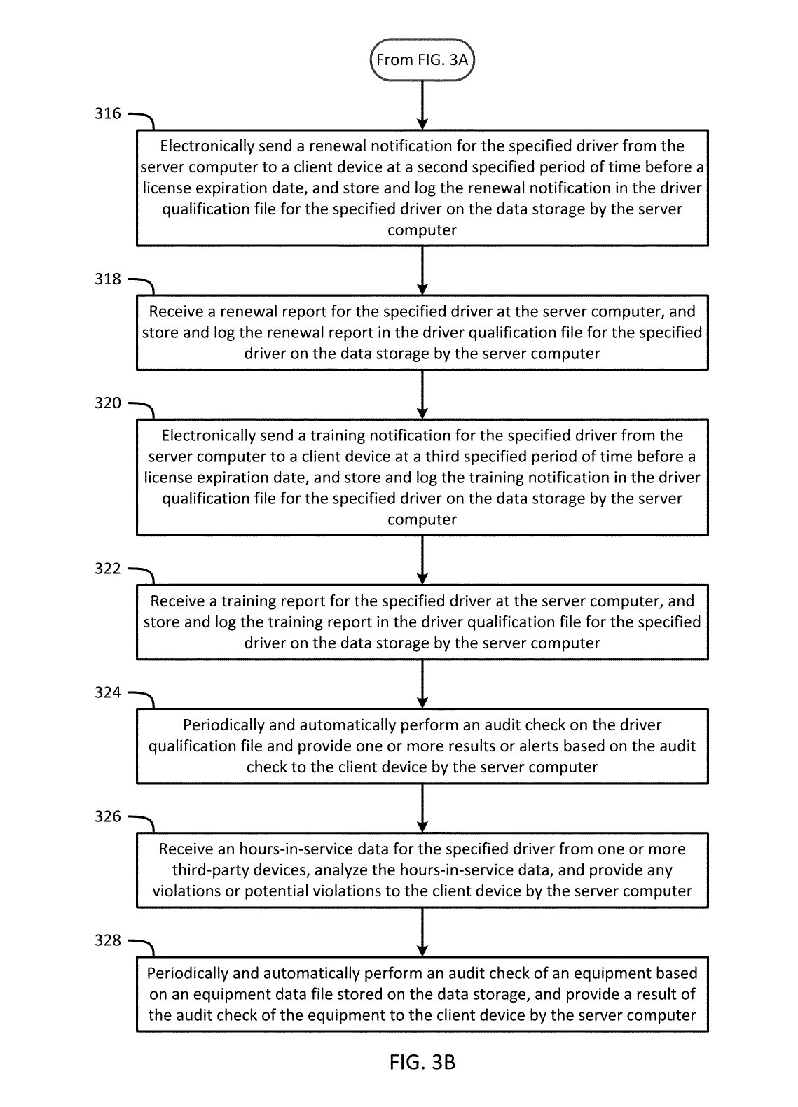

Now referring to FIGS. 3A & 3B, a flow chart of a computerized method 300 for determining compliance with a set of transportation regulations in accordance with another embodiment of the present invention is shown. A server computer, and a data storage communicably coupled to the server computer are provided in block 202. The data storage containing a driver qualification file for each of one or more drivers. The driver qualification file may include MVRs, PSPs, criminal background checks, CDLIS checks, Social Security checks, transportation checks or a combination thereof. A completed employment application for the specified driver is received by the server computer in block 302. The completed employment application for the specified driver is stored and logged in a driver qualification file for the specified driver on the data storage by the server computer in block 304. An alcohol and/or drug testing result for the specified driver is received by the server computer in block 306. The alcohol and/or drug testing result is stored and logged in the driver qualification file for the specified driver on the data storage by the server computer in block 308. One or more electronic requests for a historical record for the specified driver are automatically sent to one or more third-party databases or services in block 310. The electronic requests are stored and logged in the driver qualification file for the specified driver by the server computer in block 312. The historical records may include a work history, an accident history, a drug testing history or a combination thereof. One or more of the electronic requests for historical records for the specified driver are resent by the server computer whenever the historical records have not been received within a first specified period of time in block 314.

A renewal notification for the specified driver is sent electronically from the server computer to a client device at a second specified time period before a license expiration date, and storing and logging the renewal notification in the driver qualification file for the specified driver by the server computer in block 316. The renewal notification may include a driver license renewal, a physical exam renewal, an annual review, a MVR, or a combination thereof. A renewal report for the specified driver is received at the server computer and the renewal report is stored and logged in the driver qualification file for the specified driver on the data storage by the server computer in block 318. A training notification for the specified driver is sent electronically from the server computer to the client device at a third specified time period before a training expiration date, and the training notification is stored and logged in the driver qualification file for the specified driver by the server computer in block 320. A training report for the specified driver is received at the server computer, and the training report is stored and logged in the driver qualification file for the specified driver on the data storage by the server computer in block 322. An audit check on the driver qualification file is periodically and automatically performed, and one or more results or alerts based on the audit check are provided to the client device by the server computer in block 324. An hours-in-service data for the specified driver is received from one or more third-party devices, the hours-in-service data for the specified driver is analyzed, and any violations or potential violations are provided to the client device by the server computer in block 326. An audit check of an equipment is periodically and automatically performed based on an equipment data file stored on the data storage, and a result of the audit check of the equipment is provided to the client device by the server computer in block 328. The client device can be a carrier client device, a supervisor client device, a driver client device, an auditor client device, a third-party client device or a combination thereof. The method can be implemented as a computer program embodied on a non-transitory computer readable medium in which the computer program when executed by a processor causes the processor to perform the steps.

Other steps may be performed. For example, receiving one or more support documents for the hours-in-service data for the specified driver and storing the one or more support documents (e.g., a manifest, a bill of lading, a shipper name, a commodity type, etc. or a combination thereof) in the driver qualification file for the specified driver by the server computer.

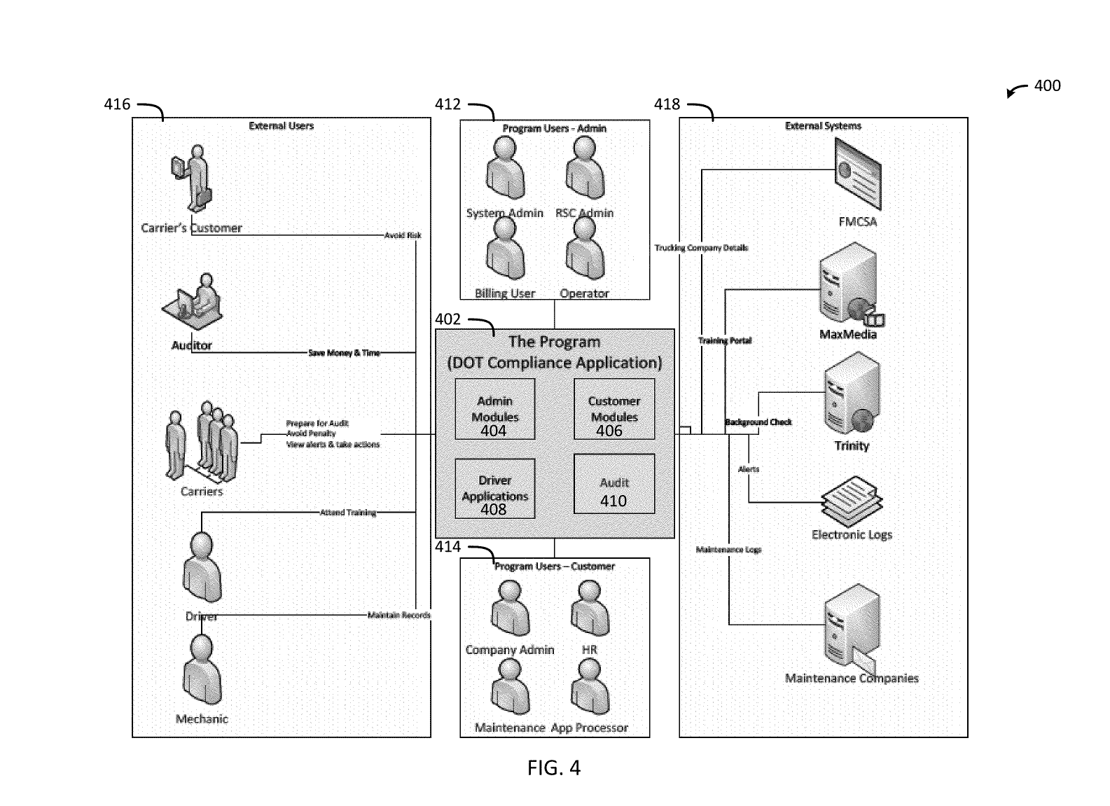

Referring now to FIG. 4, a block diagram of a system overview 400 of one embodiment of the present invention is shown. The program (DOT Compliance Application) 402 includes administration modules 404, customer modules 406, driver applications 408 and audit functions 410. The program 402 interfaces with administrative program users 412 (e.g., System Admin, RSC Admin, Billing User, Operator, etc.), customer program users 414 (e.g., Company Admin., HR, Maintenance, App Processor, etc.), external users 416 (e.g., Carrier's Customer, Auditor, Carriers, Drivers, Mechanics, etc.) and external systems 418 (e.g., FMCSA, MaxMedia, Trinity, Electronic Logs, Maintenance Companies, etc.).

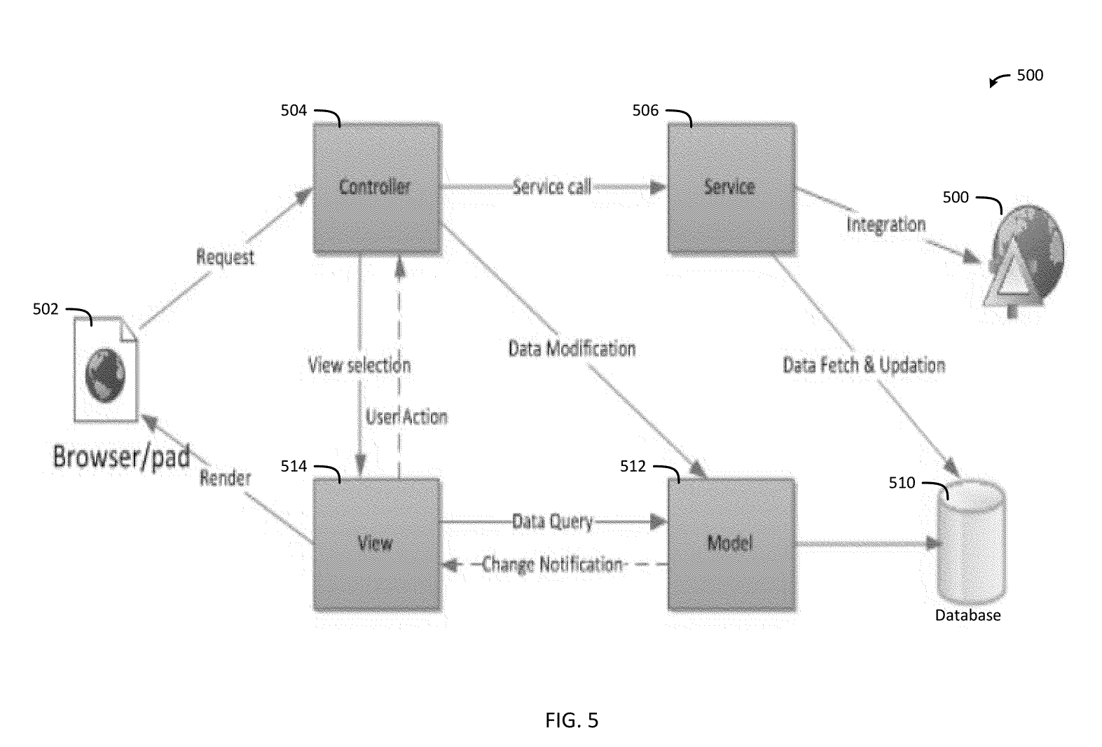

Now referring to FIG. 5, a block diagram of a logical architecture 500 of one embodiment of the present invention is shown. A client device (e.g., Browser/pad) 502 sends requests to a controller 504. The controller 504 can send service calls to service 506, which provides integration requests to the programmers 508 and data fetch and update requests to database 510. The controller 504 can also send data modification instructions to the model 512 which is communicably coupled to the database 510. In addition, the controller 504 can send view selections to the view function 514. The view function 514 renders data on the client device 502, sends user actions to the controller 504, send data queries to the model 512 and receives change notifications from the model 512.

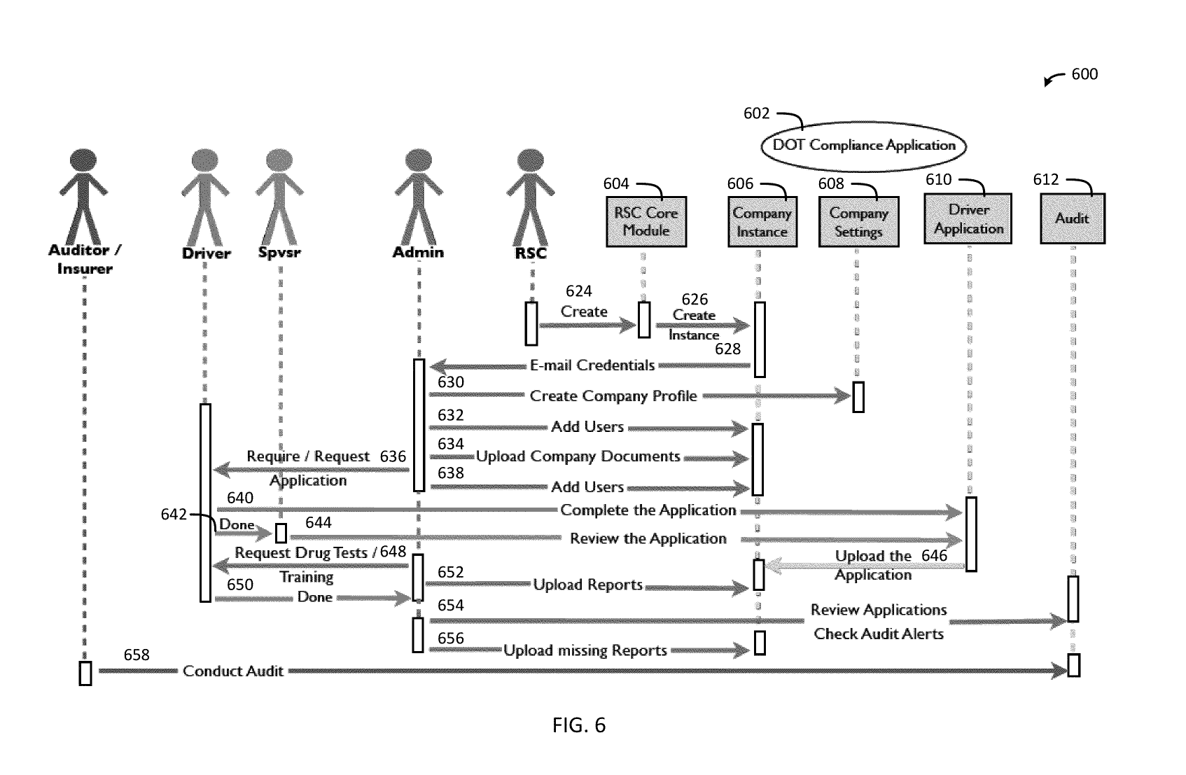

Referring now to FIG. 6, a flow chart of a driver application process 600 in accordance with one embodiment of the present invention is shown. The DOT Compliance Application 602 includes a RSC Core Module 604, a Company Instance 606, a Company Settings 608, a Driver Application 610 and an Audit Module 612. Various persons or entities (e.g., RSC Administrators 614, Company Administrator 616, Supervisor 618, Driver 620, Auditor/Insurer 622, etc.) interact with the DOT Compliance Application 602. The RSC Administrators 614 create a Company Instance 606, or Account in steps 624 and 626. The Log-in credentials are e-mailed to the point of contact, within the company/client in step 628. The Company Administrator 616 accesses their account, and completes the Company Profile to set the Company Settings 608 in step 630. This is basic information regarding the company's location, employment figures, services provided, etc. The Company Administrator 616 adds Users to the Company Instance 606 (Drivers, Managers, employees who are required to be visible to a DOT Auditor) in step 632. The Company Administrator 616 uploads currently available Company Documents pertaining to Certifications, Licensing and any other documentation required to satisfy a DOT audit to the Company Instance 606 in step 634. The Company Administrator 616 requests any available and pertinent applications, to be added to the Program in step 636. The Company Administrator 616 adds/updates users, based on new, approved applications to the Company Instance 606 in step 638. The Drivers 620 complete the Company application for employment, which is submitted to the Program (Driver Application dashboard 610) in step 640. A Supervisor 618 receives the Application in step 642, and reviews and evaluates the Application for approval or rejection using the Program (Driver Application dashboard 610) in step 644. The Application is uploaded to the Company Instance (account profile) 606 in step 646. The Company Administrator 616 schedules and manages applicant's required drug testing process in step 648. The Driver 620 completes mandated Drug Test in step 650. The Company Administrator 616 uploads Drug Test and Evaluation Reports to the Company Instance 606 in step 652. The Company Administrator 616 conducts regular reviews of employment applications, certifications and licensing using the Audit Module 612 in step 654. This is performed as a pre-audit, or audit preparation process 612. Results of the pre-audit are added to the Company Instance 606. Missing documentation is acquired, completed and uploaded to the Company Instance 606 in step 656. DOT Auditors and Insurers 622, and Company Administrators 616 can instantly access all required documentation to determine Company's compliance using the Audit Module 612 in step 658.

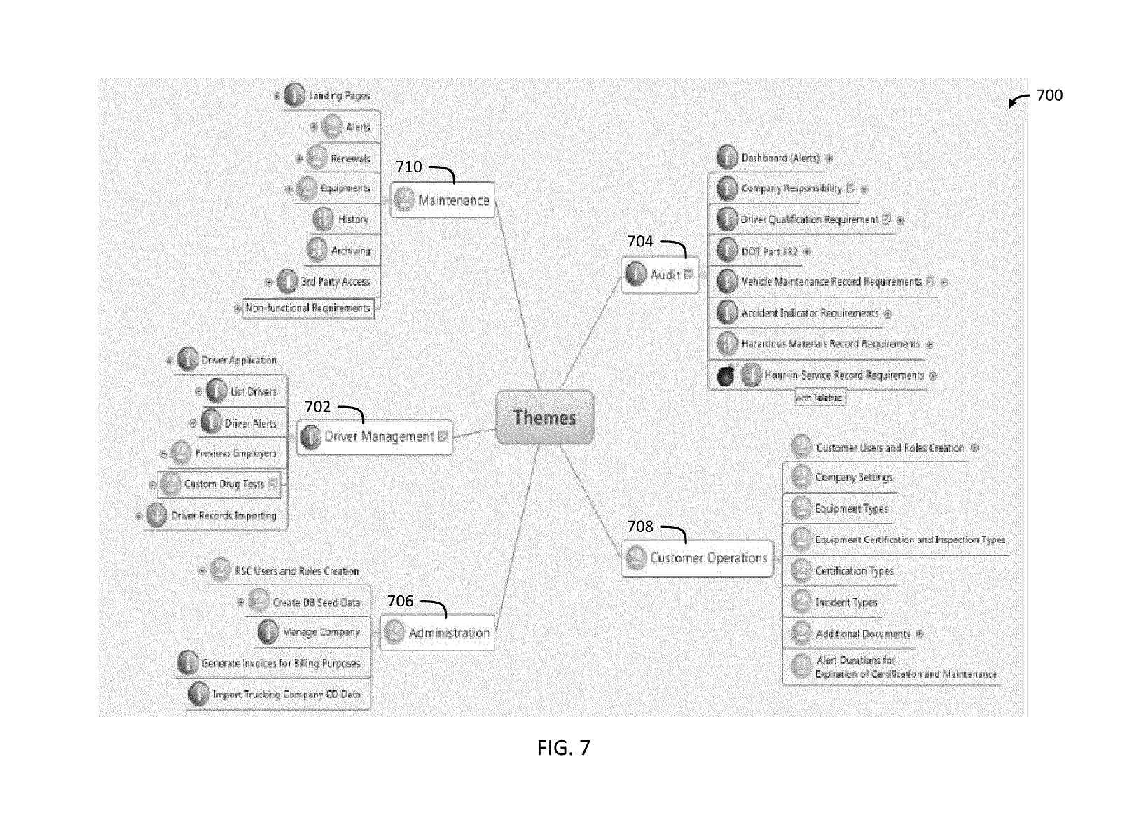

As shown in FIG. 7, one embodiment 700 of the present invention can be categorized into two primary functions (Driver Management 702 and Audits 704), and three secondary functions (Administration 706, Customer Operations 708 and Maintenance 710). Driver Management functions include Driver Application, List Drivers, Driver Alerts, Previous Employers, Custom Drug Tests and Driver Records Importing. Audit functions include Dashboard (Alerts), Company Responsibility, Driver Qualification Requirement, DOT Part 382, Vehicle Maintenance Record Requirements, Accident Indicator Requirements, Hazardous Materials Record Requirements and Hour-in-Service Record Requirements. Other primary functions can be provided as will be appreciated by those skilled in the art.

The Administration Functions include Users and Roles Creation, Create Database Seed Data, Manage Company, Generate Invoices for Billing Purposes, Import Trucking Company CD Data. The Customer Operations Functions include Customer Users and Roles Creation, Company Settings, Equipment Types, Equipment Certification and Inspection Types, Certification Types, Incident Types, Additional Documents, and Alert Durations for Expiration of Certification and Maintenance. Maintenance Functions include Landing Pages, Alerts, Renewals, Equipment, History, Archiving, Third Party Access and Non-functional Requirements. Other secondary functions can be provided as will be appreciated by those skilled in the art.

Various embodiments of the present invention may provide some or all of the functions listed below. Other functions can be provided as will be appreciated by those skilled in the art.

Audit Functions
Accident Indicator Requirements
   Upload Accident Files
   Upload Report
   Upload Required Documents
Driver Qualification Requirement
   Financial Responsibility
   Insurance Documents
Hazardous Materials Record Requirement
Hour-in Service Record Requirement
Vehicle Maintenance Record Requirement
   DVIR Information
Dashboard (Alerts)
Company Functions
Manage Company
Settings
Driver Management Functions
List Drivers
Drug Test

Landing Pages
Login Page
Audit Home Page
Company Owner Home Page
RSC Administrator Home Page
Company Settings
Driver Management Home Page
Equipment Management Home Page
Human Resources Home Page
Maintenance Home Page
Application Processor Home Page
Reports Home Page
Browser Support Functions

Latest Internet Explorer
Latest Safari
Latest Chrome
iOS 6.x, 7.x
Android 4.x

Integration Functions—Backend
Login
   Form Based Authentication
Database Design

Internationalization (I18n) Functions

Integration Functions
DOT/FMCSA
   Import Truck Company Data
Background Check Service (e.g., Trinity, etc.)
   Request MVR
   Investigative Reports
Electronic Logging Systems
Fax
Third Party Insurance and Rating Systems
Training Portal
Regulatory and Safety Consultants.

Equipment Functions
Mange Equipment Types
Equipment Certification and Inspection Types
Equipment Maintenance Alerts
Manage Equipment
Upload Equipment Documents

Certification Functions
Manage Certification Types

Incident Functions
Manage Incident Types

RSC Users and Roles Creation Functions
Manage Users and Roles
Assign Roles
Change Password
Forgot Password

Customer User Roles Creation Functions
Manage Users and Roles

Driver Application Functions
Add Driver
Update Existing Driver
Process Application
Hire
Orientation
Terminate Driver
Dismiss Application
Manage Driver Documents
Search Driver

Billing Functions
Generate Billing Related Report

Customer Functions
Manage Alert Duration

Driver Functions
Driver Alerts
Previous Employers
Driver Records Importing

Alert Functions
Manage Driver Alerts
Manage Incident Alerts
Manage Accident Alerts
Manage Application Process Alerts

Renewal Functions
Manage Renewals

History Functions

Archiving Functions

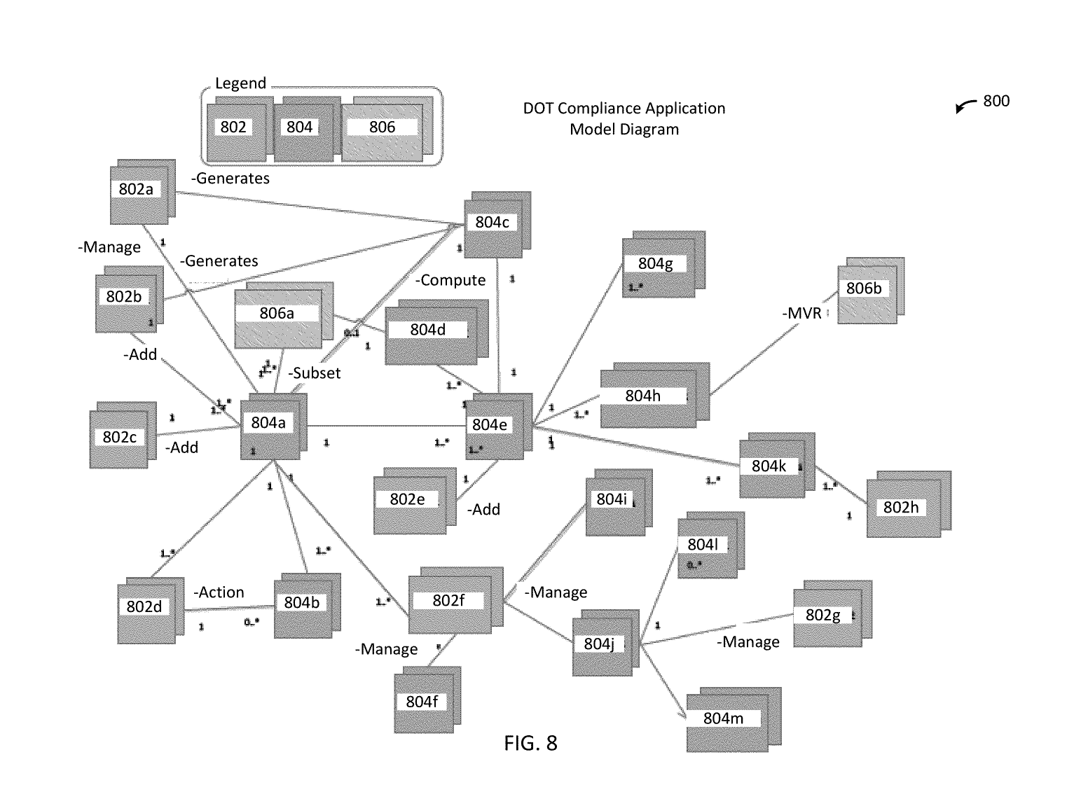

Now referring to FIG. 8, a model diagram 800 of one embodiment of the present invention is shown. The model diagram 800 depicts various actors 802, entities 804 and external systems 806. The Actors 802 include RSCAdmin 802a, Billing User 802b, Operator 802c, Supervisor 802d, App Processor 802e, Company Admin 802f, Maintenance 802g and HR 802h. The Entities 804 include Customer 804a, Alert 804b, Billing 804c, Previous Employer 804d, Driver 804e, Document 804f, Other Reports 804g, Investigative Report 804h, Accidents 804i, Equipment 804j, DOT Mandates 804k, Certificate 8041 and Equipment Type 804m. The External Systems 806 include Trucking Companies 806a and Trinity 806b.

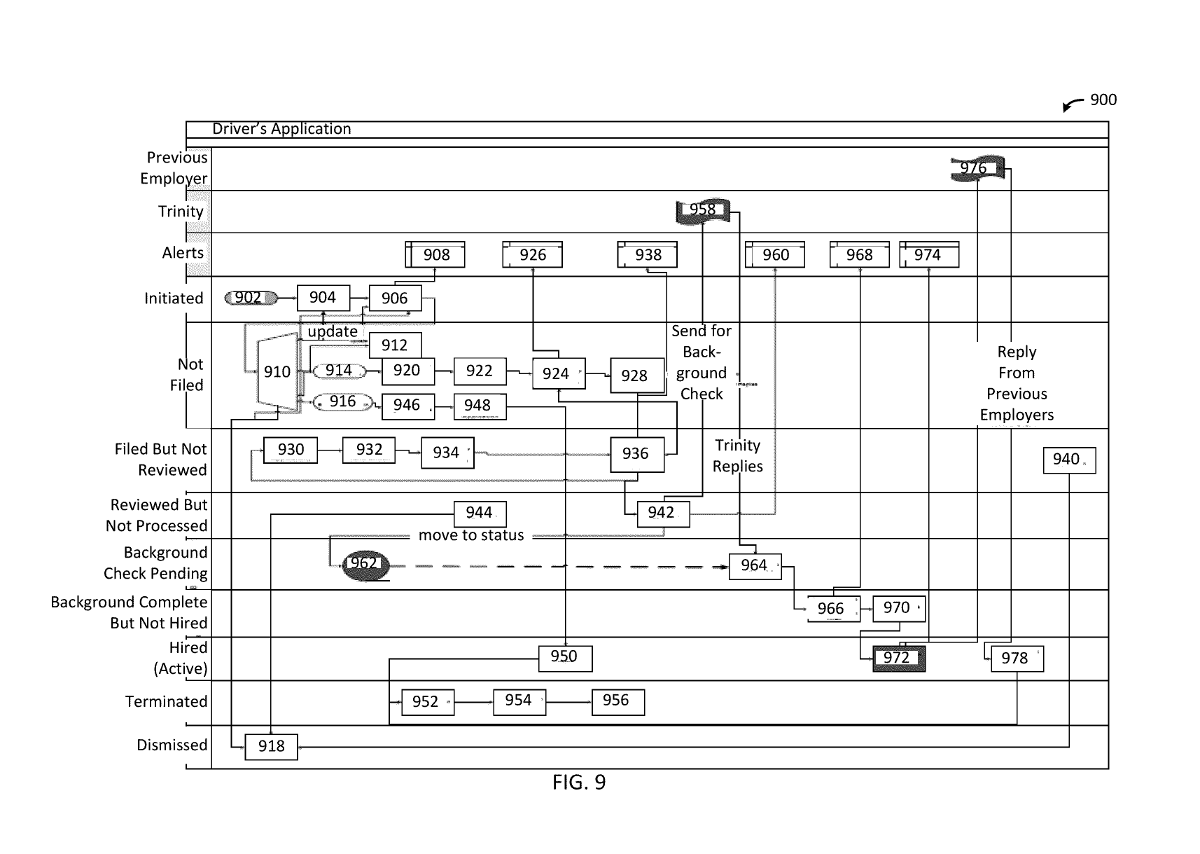

Now referring to FIG. 9, a flow chart of a Driver Application 900 in accordance with one embodiment of the present invention is shown. The Driver's Application is initiated in block 902 and basic information about the driver is entered in block 904. The driver's certification documents (images) and expiration dates are uploaded in block 906 and the application status is set to “Application Not Filed” and an alert is issued in block 908. Thereafter, various actions are taken in block 910, such as updating basic application information in block 904, updating driver's certification documents (images) and/or expiration dates in block 908, uploading additional driver documents in block 912, start scribbling new application in block 914, start uploading existing application in block 916, or dismiss the application in block 918.

With respect to start scribbling new application in block 914, every field of the application is hand written in block 920, the interviewer specifies their name (hand written) in block 922, the interviewer specified their job (hand written) in block 924, the status of the driver application is changed to “Application Filed But Not Reviewed” and an alert is issued in block 926, and the interviewer digitally signs on the designated area in block 928. The handwritten driver application is either reviewed in block 930 or dismissed in block 940 in which case the status of the application is changed to dismissed in block 918. If the handwritten driver application is reviewed in block 930, the interviewer specified their name (hand written) in block 932, the interviewer specified their job (hand written) in block 934, the interviewer digitally signs on the designated area in block 936, and the status of the driver application is changed to “Application Reviewed But Not Processed” and an alert is issued in block 938. Thereafter, the driver application is either processed in block 942 or dismissed in block 944, in which case the status of the application is changed to dismissed in block 918.

With respect to start uploading existing application in block 916, the driver's original hire date is entered in block 946, the existing handwritten application is uploaded in block 948 and the driver becomes active in block 950. If the driver is ever terminated, the termination process starts in block 952, the termination date is entered in block 954 and the reason(s) for termination are entered in block 956.

When the driver application is processed in block 942, a request for a background check on the driver is sent to a third-party background database or service (e.g., Trinity, etc.) in block 958, the status of the application is changed to “Sent for Background Check” and an alert is issued in block 960, and the process waits for a response to the background check request in block 962. Once the background check for the driver is received, the reply from the third-party background database or service is recorded in block 964, the status of the driver application is changed to “Background Complete But Not Hired” in block 966, and an alert is issued in block 968. If the driver is hired, the hire date is updated in block 970, the status of the driver application is changed to “Hired Active” and a previous employment verification process is trigger in block 972, and an alert “Orientation Pending” is issued in block 974. The system requests previous employment verification from the driver's employers (email only) in block 976. Once replies are received from the previous employers, orientation is begun and any additional documents are uploaded to the driver verification file in block 978. If the driver is ever terminated, the termination process starts in block 952, the termination date is entered in block 954 and the reason(s) for termination are entered in block 956.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present invention have been described in detail, it will be understood by those skilled in the art that various modifications can be made therein without departing from the spirit and scope of the invention as set forth in the appended claims.

What is claimed is:

1. A computerized method for determining compliance with a set of transportation regulations, the method comprising the steps of:
providing a server computer, and a data storage communicably coupled to the server computer, the data storage containing a driver qualification file for each of one or more drivers;
receiving a driver application data for a specified driver of the one or more drivers by the server computer;
storing and logging the driver application data in the driver qualification file for the specified driver by the server computer;
receiving a driver data for the specified driver of the one or more drivers by the server computer;
storing and logging the driver data in the driver qualification file for the specified driver by the server computer;
performing an electronic audit of the driver qualification file for the specified driver by the server computer to determine whether the driver application data and driver data within the driver qualification file complies with the set of transportation regulations; and
providing a result of the electronic audit to a client device communicably coupled to the server computer.

2. The method as recited in claim 1, further comprising the step of logging all changes to the driver qualification file with a date, time and source stamp.

3. The method as recited in claim 1, further comprising the step of locking the driver qualification file against unauthorized changes.

4. The method as recited in claim 1, further comprising the step of updating the set of transportation regulations.

5. The method as recited in claim 1, wherein:
the driver application data comprises a completed employment application for the specified driver, an alcohol and/or drug testing result from the specified driver, a background check result for the specified driver, a certification data for the specified driver, a historical data for the specified driver, an orientation data, or a combination thereof; and
the driver data comprises a renewal data for the specified driver, a training data for the specified driver, an hours-in-service data for the specified driver, one or more support documents for the specified driver, or a combination thereof.

6. The method as recited in claim 1, further comprising the step of sending an employment application for the specified driver electronically from the server computer to a client device, and the driver application data comprises a completed employment application for the specified driver.

7. The method as recited in claim 1, the driver application data comprises a completed employment application for the specified driver and further comprising the steps of:
receiving an interview data for the specified driver; and
storing and logging the interview data in the driver qualification file for the specified driver.

8. The method as recited in claim 1, further comprising the step of changing a status of the specified driver based on the driver application data and the driver data within the driver qualification file for the specified driver.

9. The method as recited in claim 1, the driver application data comprises a completed employment application for the specified driver and further comprising the steps of:
automatically sending an electronic request for a historical data for the specified driver to one or more third-party databases or services; and
logging the electronic request in the driver qualification file for the specified driver.

10. The method as recited in claim 9, further comprising the step of resending and logging the electronic request for the historical data for the specified driver whenever the historical data has not been received within a specified period of time.

11. The method as recited in claim 1, further comprising the steps of:
automatically sending a renewal notification for the specified driver electronically from the server computer to a client device at a specified time period before an expiration date; and
logging the renewal notification in the driver qualification file for the specified driver;

12. The method as recited in claim 1, further comprising the steps of:
receiving a renewal report for the specified driver at the server computer; and
saving and logging the renewal report in the qualification file for the specified driver on the data storage.

13. The method as recited in claim 1, further comprising the steps of:
automatically sending a training notification for the specified driver electronically from the server computer to a client device at a specified time period before an expiration date; and
logging the training notification in the driver qualification file for the specified driver.

14. The method as recited in claim 1, further comprising the steps of:
receiving a training report for the specified driver at the server computer; and
saving and logging the training report in the driver qualification file for the specified driver on the data storage.

15. The method as recited in claim 1, further comprising the steps of:
receiving an hours-in-service data for the specified driver from one or more third-party databases or services;
saving and logging the hours-in-service data in the driver qualification file for the specified driver on the data storage; and
analyzing the hour-in-service data for the specified driver and reporting any violations or potential violations to the client device.

16. The method as recited in claim 15, further comprising the step of receiving one or more support documents for the hours-in-service data for the specified driver and storing one or more support documents in the driver qualification file.

17. The method as recited in claim 1, further comprising the steps of:
receiving an equipment data for a specified equipment; and
saving and logging the equipment data for the specified equipment on the data storage.

18. The method as recited in claim 17, further comprising the steps of:
periodically and automatically performing an audit check of the specified equipment; and
providing a result of the audit check of the specified equipment to the client device.

19. An apparatus for determining compliance with a set of transportation regulations comprising:
a server computer;
a data storage communicably coupled to the server computer, the data storage containing a driver qualification file for each of one or more drivers; and
the server computer having a computer program embodied on a non-transitory computer readable medium that when executed causes the server computer to receive a driver application data for a specified driver of the one or more drivers, store and log the driver application data in the driver qualification file for the specified driver, receive a driver data for the specified driver of the one or more drivers, store and log the driver data in the driver qualification file for the specified driver, perform an electronic audit of the driver qualification file for the specified driver to determine whether the driver application data and driver data within the driver qualification file complies with the set of transportation regulations, and provide a result of the electronic audit to a client device communicably coupled to the server computer.

20. The apparatus as recited in claim 19, further comprising a network communicably coupling the server computer to the client device.

21. The apparatus as recited in claim 20, the network comprising the Internet, a wireless network, a public or private wide area or local area network, a cellular network, an optical network, a satellite network or a combination thereof.

22. The apparatus as recited in claim 19, the server computer comprises a distributed network of computers communicably coupled to one another.

23. The apparatus as recited in claim 19, the server computer is remotely located with respect to the data storage and the data storage is a distributed network of data storage devices communicably coupled to one another.

24. The apparatus as recited in claim 19, the server computer providing a web-based interface to the client device.

25. The apparatus as recited in claim 19, further comprising one or more third-party databases or services communicably coupled to the server computer.

26. The apparatus as recited in claim 19, the client device further comprising a workstation, a client computer, a laptop, a mobile computing tablet, a mobile phone, an input and/or output device, a user interface on an equipment.

27. A computerized method for determining compliance with a set of transportation regulations, the method comprising the steps of:
providing a server computer, and a data storage communicably coupled to the server computer, the data storage containing a driver qualification file for each of one or more drivers;
receiving a completed employment application for the specified driver by the server computer;
storing and logging the completed employment application for the specified driver in a driver qualification file for the specified driver on the data storage by the server computer;
receiving an alcohol and/or drug testing result for the specified driver by the server computer;
saving and logging the alcohol and/or drug testing result in the driver qualification file for the specified driver on the data storage by the server computer;
automatically sending one or more electronic requests for a historical record for the specified driver to one or more third-party databases or services;
saving and logging the electronic requests in the driver qualification file for the specified driver by the server computer;
resending and logging one or more of the electronic requests for historical records for the specified driver whenever the historical records have not been received within a first specified period of time;
sending a renewal notification for the specified driver electronically from the server computer to a client device at a second specified time period before a license expiration date, and storing and logging the renewal notification in the driver qualification file for the specified driver by the server computer;
receiving a renewal report for the specified driver at the server computer and saving and logging the renewal report in the driver qualification file for the specified driver on the data storage by the server computer;
sending a training notification for the specified driver electronically from the server computer to the client device at a third specified time period before a training expiration date, and storing and logging the training notification in the driver qualification file for the specified driver by the server computer;
receiving a training report for the specified driver at the server computer, and saving and logging the training report in the driver qualification file for the specified driver on the data storage by the server computer;
periodically and automatically performing an audit check on the driver qualification file, and providing one or more results or alerts based on the audit check to the client device;
receiving an hours-in-service data for the specified driver from one or more third-party devices, and analyzing the hour-in-service data for the specified driver and reporting any violations or potential violations to the client device; and
periodically and automatically performing an audit check of an equipment based on an equipment data file stored on the data storage, and reporting a result of the audit check of the equipment to the client device by the server computer.

28. The method as recited in claim 27, the client device comprising a carrier client device, a supervisor client device, a driver client device, an auditor client device, a third-party client device or a combination thereof.

29. The method as recited in claim 27, further comprising the step of receiving one or more support documents for the hours-in-service data for the specified driver and storing the one or more support document in the driver qualification file for the specified driver by the server computer.

30. The method as recited in claim 29, the one or more support documents comprise a manifest, a bill of lading, a shipper name, a commodity type or a combination thereof.

31. The method as recited in claim 27, the driver qualification files including MVRs, PSPs, criminal background checks, CDLIS checks, Social Security checks, transportation checks or a combination thereof.

32. The method as recited in claim 27, the historical record for the specified driver comprising a work history, an accident history, a drug testing history or a combination thereof.

33. The method as recited in claim 27, the renewal notification comprising a driver license renewal, a physical exam renewal, an annual review, a MVR, or a combination thereof.
